(19) United States
(12) Patent Application Publication
(10) Pub. No.: US 2023/0179583 A1
(43) Pub. Date: Jun. 8, 2023

(54) SECURE NETWORK LINKS OVER ENCRYPTION-INCAPABLE PORTS IN ACCESS-CONTROLLED NETWORK DOMAIN

(71) Applicant: Cisco Technology, Inc., San Jose, CA (US)

(72) Inventors: Mahasen Bhagvath, Bangalore (IN); Gireesha Thimmanna Maldhakal, Harihar (IN)

(21) Appl. No.: 17/545,958

(22) Filed: Dec. 8, 2021

(51) Int. Cl. H04L 9/08

(52) U.S. Cl. CPC H04L 63/0485; H04L 9/0819; H04L 63/16

(57) ABSTRACT

Methods and devices establish a secure network link between an encryption-capable port and an encryption-incapable port in an access-controlled network domain. A processing unit of a network device configures the network device to secure a network link between an encryption-incapable port of the network device and a port of a peer network device using security association keys (“SAKs”) of a security association (“SA”) exchanged between the network device and the peer network device according to a key exchange protocol. A processing unit further configures reserving an encryption-capable port to process packets in a circular forwarding mode. A processing unit further configures a PHY of the network device to perform one of encryption or decryption over each of a first secure channel (“SC”) and a second SC using the SAKs. A processing unit further configures redirection of packets received over the SA to the reserved encryption-capable port.

### TECHNICAL FIELD

The present disclosure relates generally to establishing secure network links over encryption-incapable ports of network devices of one or more networks of the access-controlled network domain.

### BACKGROUND

Network Access Control (“NAC”) describes a collection of techniques which implement various policy-based protocols for allowing and blocking access to computer networks. NAC does not describe any singular technique or protocol, but rather a variety of protocols implemented by a variety of techniques, which conceptually define access policies at a host network, and enforce those policies to allow and block access to the host network from various client computers.

Among techniques and standards developed to implement NAC, extensions to the Institute of Electrical and Electronics Engineers (“IEEE”) 802 local area networks (“LAN”) standards play a prominent role. In particular, 802 LAN standards establish media access control (“MAC”), including hardware-level functionalities which control access to a physical transmission medium of a network. The IEEE has extended 802 LAN standards to establish the 802.1X standard, which implements an authenticator which communicates with an authentication server to allow or block traffic between the client and the network. Furthermore, the IEEE has extended 802 LAN standards to establish the 802.1AE standard, which implements MACsec, which preserves security of data transmitted over a network, by encrypting packets transmitted over a network interface. These standards may be implemented on network devices making up an access-controlled network domain.

However, network devices based on integrated circuits having encryption and decryption functionality are substantially more costly on the market than network devices not having such functionality. As a result, for network administrators responsible for network domains where NAC is enforced by the 802.1AE standard, hardware costs will compound as underlying networks scale up. Consequently, network administrators must incur substantial costs to design a network architecture in accordance with NAC principles. Moreover, once implemented, a network designed in accordance with NAC principles cannot be upgraded without incurring additional hardware costs to scale up encryption and decryption functionality. There is a need to enable NAC techniques and protocols to be implemented over networks in a more flexible fashion.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The devices depicted in the accompanying figures are not to scale and components within the figures may be depicted not to scale with each other.

FIG. 1 illustrates an access-controlled network domain implemented over a physical layer of one or more networks, according to example embodiments of the present disclosure.

FIG. 2 illustrates a device-architecture diagram of an example network device implementing establishment of secure network links over encryption-incapable ports, according to example embodiments of the present disclosure.

FIG. 3 illustrates a flowchart of a secure network link establishing method according to example embodiments of the present disclosure.

FIG. 4 illustrates a flowchart of a surrogate decryption method according to example embodiments of the present disclosure.

FIG. 5 illustrates a flowchart of a surrogate encryption method according to example embodiments of the present disclosure.

FIG. 6 shows an example architecture for a network device capable of being configured to implement the functionality described above.

### DESCRIPTION OF EXAMPLE EMBODIMENTS

### Overview

This disclosure describes techniques for upgrading an access-controlled network domain without modifying physical layer circuit configuration, by enabling encryption-incapable ports of network devices to establish secure network links across one or more networks of the access-controlled network domain.

The described techniques may be implemented in one or more network devices having one or more processing units configured to execute computer-executable instructions, which may be implemented by, for example, one or more application specific integrated circuits (“ASICs”). The processing units may be configured by one or more non-transitory computer-readable media storing computer-executable instructions that, when executed by the processing units cause the processing units to perform the steps.

The method includes a processing unit of a network device configuring an encryption-incapable port of the network device to establish a connectivity association (“CA”) with a peer port based on common connectivity association keys (“CAKs,” which are identified by connectivity association key names “CKNs”); negotiate a security association (“SA”) based on generating security association keys (“SAKs”) from the CAKs and distributing SAKs to the CA members; and establishing a secure network link to the peer port, the link being secured by exchanging the SAKs according to a key exchange protocol. The method further includes a processing unit reserving an encryption-capable port to process packets in a circular forwarding mode. The method further includes a processing unit securing transmissions over a first secure channel (“SC”) and a second SC of the network device each by performing one of encryption or decryption using the SAKs. The method further includes a processing unit configuring redirection of packets received over the SA to the reserved encryption-capable port.

Additionally, the techniques described herein may be performed by a device having non-transitory computer-readable media storing computer-executable instructions that, when executed by one or more processors, performs the method described above.

### EXAMPLE EMBODIMENTS

According to example embodiments of the present disclosure, an access-controlled network domain refers to some number of commonly administrated networks configured over an infrastructure including network hosts and network devices in communication according to one or more network protocols. Connection to any network of the access-controlled network domain by any networked device (“endpoint”) outside of the network domain is subject to access controls which may allow or may block the connection. One or more networks according to example embodiments of the present disclosure may include wired and wireless local area networks (“LANs”) and such networks supported by IEEE 802 LAN standards. Network protocols according to example embodiments of the present disclosure may include any protocol suitable for delivering data packets through one or more networks, such as IP data routing.

It should be understood that there is no categorical distinction between networked devices connecting to the network domain (such as endpoints, by way of example) and networked hosts within the network domain; the term “endpoint” as used herein merely logically distinguishes devices connecting to the network domain from hosts within the network domain.

According to example embodiments of the present disclosure, network devices of the access-controlled network domain may include routers and switches. A network device may be a physical electronic device having one or more processing units configured to execute computer-executable instructions, which may be implemented by, for example, one or more application specific integrated circuits (“ASICs”). The processing units may be configured by one or more non-transitory computer-readable media storing computer-executable instructions that, when executed by the processing units cause the processing units to perform the steps. For example, the computer-executable instructions may be stored on memory of one or more ASICs. According to example embodiments of the present disclosure, memory may include, for example, ternary content addressable memory (“TCAM”), which an ASIC may be configured to write data to and read data from.

In one or more networks of the access-controlled network domain, a physical layer of the network may be defined by some number of such network devices.

A network device such as a router or switch may receive packets forwarded over one or more network links from a host internal to or external to the one or more networks; determine a next hop, route, and/or destination to forward the packets to; and forward the packets to a host internal to or external to the one or more networks, determined by the next hop, route, and/or destination. A network device may be configured to determine a next hop, route, and/or destination by any combination of static routing tables and various dynamic routing algorithms.

According to example embodiments of the present disclosure, “access controls” may refer to any implementation of LAN standards which allow access to some endpoints outside the access-controlled network domain, and block access to other endpoints outside the access-controlled network domain to a physical transmission medium of one or more networks of the access-controlled network domain. Allowance and blocking of access may reflect various security policies which describe endpoints which are authorized to access the access-controlled network domain and endpoints which are not authorized to access the access-controlled network domain. For example, a security policy may be based on an identity of an endpoint device being that of a device authorized to access the access-controlled network domain; an identity of a user of an endpoint device being that of a user authorized to access the access-controlled network domain; a software configuration of an endpoint device complying with security standards conditional to access the access-controlled network domain; security of an endpoint device not being compromised by a malicious attack; and such rules as a network administrator may define for the purpose of securing the access-controlled network domain against unauthorized access.

Among network devices of one or more networks of the access-controlled network domain, some network devices may be configured as network access devices. Network access devices may perform ingress enforcement by determining characteristics of an endpoint; comparing characteristics of an endpoint to a security policy; and then classifying the endpoint having the characteristics as belonging to one of multiple groups, including at least one group made up of endpoints authorized to access the access-controlled network domain, and at least one group made up of endpoints not authorized to access the access-controlled network domain. Such a security policy may include any of, but need not be limited to, the above examples of security standards.

Network access devices may be configured to perform ingress enforcement by various authentication protocols. An authentication protocol may include the IEEE 802.1X LAN standard, which configures the network access device as an authenticator which receives credentials sent over a network link from a supplicant running on an endpoint, sends received credentials to an authentication server (outside the access-controlled network domain) for validation, and, based on validation outcomes returned from the authentication server, allows or blocks traffic between the endpoint and one or more networks of the access-controlled network domain. Furthermore, an authentication protocol according to the 802.1X standard may be extended in accordance with the 802.1X-REV standard, which configures the network access device to further perform key exchange based on the MACsec Key Agreement (“MKA”) protocol.

An authentication protocol may include the MAC Authentication Bypass protocol, which configures the network access device as an authenticator which determines a MAC address of the endpoint, sends the MAC address to an authentication server for validation, and, based on validation outcomes returned from the authentication server, allows or blocks traffic between the endpoint and one or more networks of the access-controlled network domain.

An authentication protocol may include any other suitable protocol implemented in accordance with World Wide Web standards for authenticating an endpoint device, or a user of the endpoint device, as being authorized to access a network, such as Web Authentication as published by the World Wide Web Consortium. Such other authentication protocols may likewise configure the network access device as an authenticator which determines authentication credentials of the endpoint according to the protocol, sends the authentication credentials to an authentication server for validation, and, based on validation outcomes returned from the authentication server, allows or blocks traffic between the endpoint and one or more networks of the access-controlled network domain.

Furthermore, the validation outcome returned from the authentication server may further include one or more authorization policies. Authorization policies may configure network access devices to identify various endpoints, and classify data packets received from endpoints in accordance with respective endpoint identities. For example, authorization policies may configure network access devices to identify endpoints as assigned to different security groups, and to tag packets received from endpoints of different security groups with different security group tags (“SGTs”). For example, authorization policies may configure network access devices to enforce access control lists (“ACLs”), by identifying endpoints as authorized to access the access-controlled network domain or not authorized to access the access-controlled network domain, according to whether endpoint IP addresses are present on an ACL or not.

Furthermore, authorization policies may configure network access devices to tag packets with SGTs, and to enforce ACLs by identifying endpoints as authorized to access the access-controlled network domain or not authorized to access the access-controlled network domain according to whether data packets are tagged with SGTs present on an ACL or not. According to example embodiments of the present disclosure, such authorization policies are referenced as security group based access control lists (“SGACLs”). Such role-based ACLs may map a group of IP addresses to a common role (e.g., a common security group number), minimizing the size of data stored in ACLs.

Thus, after any authenticator as described above has validated authorization of an endpoint to access one or more networks of the access-controlled network domain and has allowed traffic between the endpoint and the one or more networks, data packets originating from the endpoint may be tagged with an SGT at a network access device 104. Subsequently, network devices of the access-controlled network domain may forward tagged packets across any number of network links across one or more networks of the access-controlled network domain.

Access-controlled network domains according to example embodiments of the present disclosure further implement secure transmission of data over network links. Network devices of an access-controlled network domain may be configured to securely transmit data by, for example, encrypting packets according to an encryption standard enforced by a network security protocol. A network security protocol may include the IEEE 802.1AE LAN standard, which configures any number of ports of a network device to encrypt and decrypt packets according to the Media Access Control Security (“MACsec”).

In a network device as a whole, transceiver integrated circuits underlying the sending and receiving functionality of ports according to LAN standards may be each referred to as a physical layer circuit, commonly referred to as an “Ethernet PHY” or “PHY.” The physical circuit design of each PHY may determine characteristics of a respective port of a network device, such as a bitrate of each respective port and the LAN standards which each respective port may support in sending and receiving packets. Subsequently, for ease of reference, a “port” according to example embodiments of the present disclosure shall refer to one or more integrated circuits of a PHY which define transceiver functionalities of a respective port of a network device.

Generally, according to example embodiments of the present disclosure, PHYs have encryption and decryption circuits which may be configured to perform encryption and decryption of data according to one or more encryption standards (such as Advanced Encryption Standard (“AES”)). For the present disclosure, a port of such a PHY may be referenced as an “encryption-capable port.”

In addition to encryption-capable ports having encryption and decryption circuits, encryption-capable ports generally also provide greater bandwidth than encryption-incapable ports (for example, encryption-incapable ports as known to persons in the art commonly support a bitrate of 10 gigabits per second, while encryption-capable ports commonly support a bitrate of 40 gigabits per second, or may support as much as 100 gigabits per second). For these reasons, a PHY having an encryption-capable port is substantially more costly to produce and to purchase than a PHY having an encryption-incapable port.

Across a pair of ports of network devices communicating by a network link, the two peer network devices may establish a common connectivity association (“CA”). Two peer network devices may establish a CA between a pair of their respective ports by the distribution of matching CAKs and CKNs to the two peer network devices. An external server (not illustrated herein) may generate CAKs and CKNs and distribute them to the peer network devices. Alternatively, a network administrator may manually configure both peer network devices with matching CAKs and CKNs as pre-shared keys.

Moreover, the negotiation of the CA allows the peer network devices to negotiate a common security association (“SA”) between a pair of their respective ports. The negotiation of a SA between respective ports of the two peer network devices may be performed by exchange of security association keys (“SAKs”), derived from the CAKs of the above-mentioned CA, between the two ports according to a key exchange protocol, such as Security Association Protocol (“SAP”), MKA protocol as described above, and the like. By negotiation of a SA between two ports, SAKs exchanged between the two ports secure outbound traffic over transmitting SCs from either port PHY to the other and inbound traffic over receiving SCs from either port PHY to the other, allowing either port (in the event that both ports are encryption-capable ports) to encrypt packets which the other port may decrypt, and to decrypt data packets encrypted by the other port. For the purpose of an access-controlled network domain, each network link between network devices of the network domain must be a secure network link.

For the purpose of understanding example embodiments of the present disclosure, it should be understood that a pair of ports may perform a key exchange protocol even if one port is encryption-incapable, or both ports are encryption-incapable, as a key exchange protocol merely requires the exchange of data, without the performance of encryption and decryption. Conventionally, two ports merely exchanging messages according to a key exchange protocol would not suffice to establish a secure network link, as the exchanged keys would serve no security purpose if either port is not actually capable of performing encryption and decryption. Thus, encryption-incapable ports are not conventionally configured to perform a key exchange protocol to negotiate SAs; even if encryption-incapable ports were configured to perform a key exchange protocol, they would still not be capable of establishing a secure network link.

The above-mentioned techniques for implementing an access-controlled network domain may be implemented individually, or may be implemented collectively in any suitable combination thereof, where any of the above-mentioned techniques may be replaced with a suitable technique known to persons skilled in the art for implementing a similar outcome, without limitation to the above-described techniques. For example, CISCO SYSTEMS, INC. of San Jose, California provides various network architectures under the CISCO TRUSTSEC name, which describes various collective implementation of the above-described techniques over one or more networks to implement an access-controlled network domain.

It should be understood, however, that example embodiments of the present disclosure may be implemented according to any of the several versions of the CISCO TRUSTSEC specifications as known to persons skilled in the art, or may be implemented according to other specifications for access-controlled network domains as described above. For example, while the implementation of SGTs, ACLs, or SGACLs may facilitate authorization of endpoint devices joining an access-controlled network domains (and the use of TCAM lookup by a processing unit according to implementations of SGACLs, for example, does not conflict with the modifications to TCAM lookup as shall be subsequently described), persons skilled in the art will appreciate that access-controlled network domains may be implemented without these techniques. Access-controlled network domains may be implemented by implementing only an authentication protocol and a network security protocol over one or more networks underlying the access-controlled network domain, such as according to standalone implementations of MACsec.

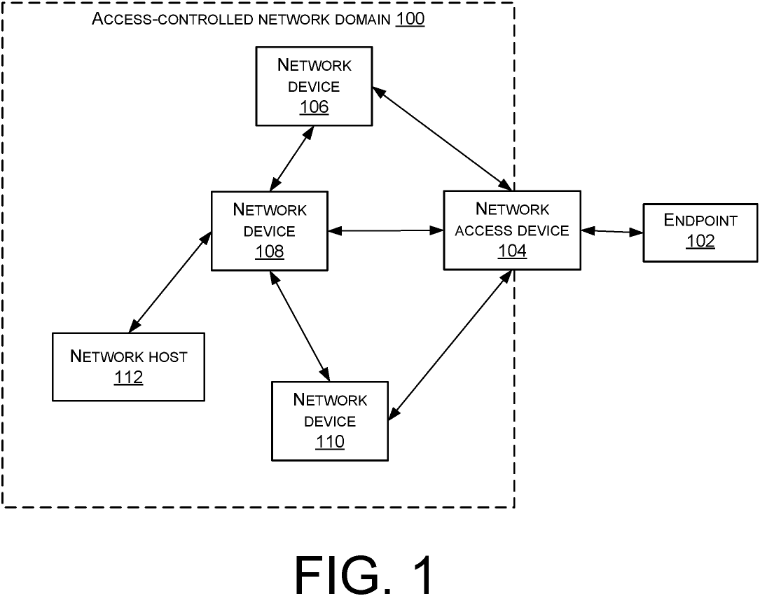

FIG. 1 illustrates an access-controlled network domain 100 implemented over a physical layer of one or more networks, according to example embodiments of the present disclosure. An endpoint 102, addressed outside of the one or more networks and outside the access-controlled network domain 100, accesses the access-controlled network domain 100 by an ingress network link to a network access device 104, such as a network link to a switch configured as an authenticator. Further example network devices of one or more networks of the access-controlled network domain 100 are labeled herein as 106, 108, and 110, but it should be understood that the one or more networks may include any number of other network devices not illustrated herein. One or more networks of the access-controlled network domain 100 may further include any number of network hosts; an example network host of one or more networks of the access-controlled network domain 100 is labeled herein as 112, but it should be understood that the one or more networks may include any number of other network hosts not illustrated herein.

It should be understood that there is no categorical distinction between networked devices connecting to the network domain (such as endpoints, by way of example) and networked hosts within the network domain; the term “endpoint” as used herein merely logically distinguishes devices connecting to the network domain from hosts within the network domain.

It should further be understood that any number of network links may be established between network devices of the one or more networks and/or network hosts of the one or more networks, including secure network links and non-secure network links. The network links illustrated in FIG. 1 should be understood as being secure network links. Further secure and/or non-secure network links between the illustrated network devices and network hosts may be established, but they are not illustrated herein. Further network links may be established from the illustrated network devices and network hosts to other network devices and network hosts not part of the one or more networks of the access-controlled network domain 100; these further network links, whether secure or non-secure, are not illustrated herein.

Further hosts described above which are not part of the access-controlled network domain 100, such as an authentication server, are also not illustrated herein.

Each packet which ingresses into the access-controlled network domain 100 may only be routed over secure network links in order to ultimately egress from the network domain. However, it should be understood that not all network devices have encryption-capable ports, and even for network devices having encryption-capable ports, not all ports of such a network device are necessarily encryption-capable ports. Since encryption-capable ports substantially elevate hardware costs over more conventional, non-encryption-capable ports, during the design of network infrastructure, it is desirable for most network-hosting organizations to utilize no more encryption-capable ports than necessary. Consequently, in an access-controlled network domain, one or more networks may include any number of network devices which cannot establish a secure network link between one or more of their respective ports. Thus, the number of network devices of the one or more networks having one or more encryption-capable ports, as well as the number of encryption-capable ports among the one or more networks, limits the scale of the access-controlled network domain.

A network-hosting organization which has purchased some number of physical network devices implemented a network infrastructure including one or more networks, and configured an access-controlled network domain over these one or more networks based on the physical network infrastructure, may later wish to change the configuration of the access-controlled network domain. For example, the organization may wish to scale up the access-controlled network domain to serve more customers. Moreover, even if the organization does not scale up the access-controlled network domain to serve more customers, increased traffic from existing customers may require the organization to establish more secure network links in the access-controlled network domain.

In both cases, the organization may choose to physically upgrade network devices underlying an access-controlled network domain by adding encryption-capable ports, replacing network devices having fewer encryption-capable ports with upgraded network devices having more encryption-capable ports, and the like. In order to establish new secure network links between new pairs of encryption-capable ports, such purchases may incur a substantial PHY cost. PHY costs may be a particular concern to network-hosting organizations which implement networks, including enterprise networks, according to end-of-row data center or enterprise network design, wherein a single physical chassis houses aggregated switch line cards (“LCs”) for each host among a set of server hosts. Aggregated switch LCs may include a mix of LCs having encryption-capable ports and LCs not having encryption-capable ports, in order to minimize costs. Thus, it is desired to upgrade the number of encryption-capable ports installed at a set of server racks while avoiding adding further LCs having encryption-capable ports, such as in the event that LC slots of the end-of-row chassis are all filled and no LCs may be added.

Thus, example embodiments of the present disclosure provide methods and devices to establish a secure network link between any two ports including at least one encryption-incapable port in an access-controlled network domain. Methods and devices according to example embodiments of the present disclosure may enable network-hosting organizations to establish new secure network links in an existing access-controlled network domain without incurring additional PHY costs.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

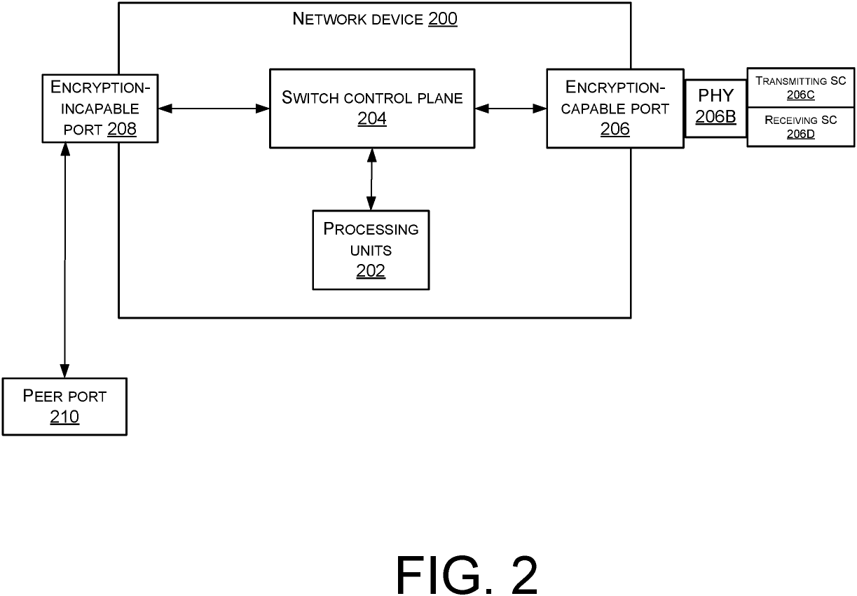

FIG. 2 illustrates a device-architecture diagram of an example network device 200 implementing establishment of secure network links over encryption-incapable ports, according to example embodiments of the present disclosure.

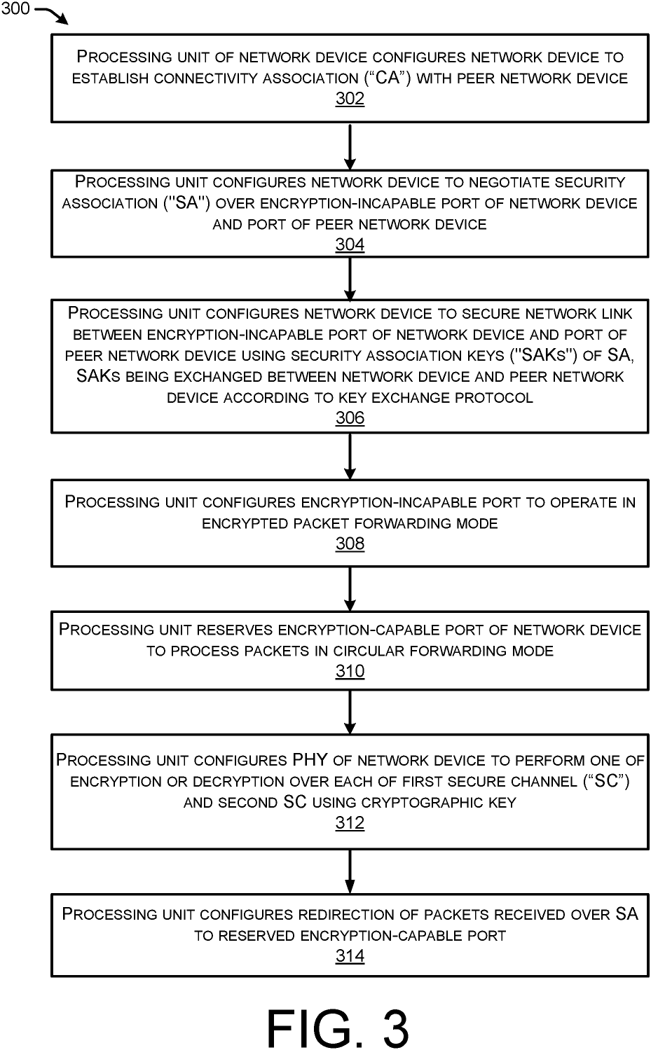

As described above, the network device 200 may be an electronic device having one or more of multiple types of hardware modules (or nodes) installed, including processing units 202. The processing units 202 may be implemented by, for example, one or more ASICs configured to perform each of the steps as subsequently described with reference to the method of FIG. 3. The processing units 202 may be configured to perform each of the below-described steps by one or more non-transitory computer-readable media storing computer-executable instructions that, when executed by the processing units 202, cause the processing units 202 to perform the steps. For example, the computer-executable instructions may be stored on memory of one or more ASICs.

The computer-executable instructions which configure the processing units 202, as well as any data written, read, and modified in the course of executing these instructions, may be collectively referred to as a switch control plane 204.

The network device 200 further includes at least one encryption-capable port and at least one encryption-incapable port. An example encryption-capable port of the network device 200 is labeled herein as 206, but it should be understood that the network device 200 may include any number of other encryption-capable ports not illustrated herein. An example encryption-incapable port of the network device 200 is labeled herein as 208, but it should be understood that the network device 200 may include any number of other encryption-incapable ports not illustrated herein.

The underlying PHY of the example encryption-capable port 206 is further labeled as 206B, the PHY 206B being operative to transmit and receive encrypted data packets as electrical signals on at least two SCs. Herein, a transmitting SC is labeled 206C, and a receiving SC is labeled 206D.

It should be understood that the example encryption-capable port 206 may be in communication with another port of a peer network device (not illustrated herein); in the event that the example encryption-capable port 206 has established a network link with another encryption-capable port (not illustrated herein) and the respective network devices have established a CA and negotiated a SA over the network link, thereby establishing a secure network link therebetween, the network device 200, with regard to its secure network link with the peer network device, may be considered part of an access-controlled network domain 100 according to example embodiments of the present disclosure.

Additionally, FIG. 2 illustrates a peer port 210 in communication with the encryption-incapable port 208. The peer port 210 is part of a peer network device (not illustrated herein), and may be an encryption-capable port or may be another encryption-incapable port. According to conventional techniques, the encryption-incapable port 208 cannot establish a secure network link with the peer port 210 (regardless of whether the peer port 210 is encryption-capable or not), even if the encryption-incapable port 208 is configured to perform a key exchange protocol with the peer port 210. Therefore, regardless of whether the network device 200 is part of an access-controlled network domain 100, the network link between the encryption-incapable port 208 and the peer port 210 cannot be made part of the access-controlled network domain, according to conventional techniques.

Consequently, example embodiments of the present disclosure provide methods and devices by which a secure network link may be established between the encryption-incapable port 208 and the peer port 210, without modifying the PHYs of the network device 200.

FIG. 3 illustrates a flowchart of a secure network link establishing method 300 according to example embodiments of the present disclosure. As described above, each of the steps of the secure network link establishing method 300 may be performed by processing units of a network device, configured by one or more non-transitory computer-readable media storing computer-executable instructions. For example, the computer-executable instructions may be stored on memory of one or more ASICs.

In a step 302 of the secure network link establishing method 300, a processing unit of a network device configures the network device to establish a connectivity association (“CA”) with a peer network device.

Two peer network devices (i.e., the network device and the peer network device as described above) may establish a common CA by the distribution of matching CAKs and CKNs to the two peer network devices. An external server (not illustrated herein) may generate CAKs and CKNs and distribute them to the peer network devices. Alternatively, a network administrator may manually configure both peer network devices with matching CAKs and CKNs as pre-shared keys. For brevity, the network device and the peer network device may be subsequently referred to as the “CA members.”

In a step 304 of the secure network link establishing method 300, a processing unit configures the network device to negotiate a security association (“SA”) over an encryption-incapable port of the network device and a port of the peer network device (regardless of whether the port of the peer network device is encryption-capable or not).

To negotiate the SA over respective ports of the CA members, the encryption-incapable port and the peer port may perform an exchange of security association keys (“SAKs”) according to a key exchange protocol, such as SAP, MKA, and the like. Conventionally, it is impossible to negotiate a SA between these two ports of the CA members to establish a secure network link between the two ports; however, the subsequently-described steps will detail a method by which a secure network link may be established between these two ports. For the purpose of understanding step 304, it should be appreciated that SAKs are exchanged between the two ports as though either port will encrypt packets which the other port may decrypt, and will decrypt data packets encrypted by the other port, even though the encryption-incapable port cannot actually perform these operations.

As part of negotiating the SA, the ports exchange protocol data units (“PDUs”) defined according to the key exchange protocol. It should be understood that each port may receive the other port’s PDU, and processing units at the network device may be configured to record the PDU of the peer port at a switch control plane of the network device.

In a step 306 of the secure network link establishing method 300, a processing unit configures the network device to secure a network link between the encryption-incapable port of the network device and the port of the peer network device using security association keys (“SAKs”) of the SA, the SAKs being exchanged between the network device and the peer network device according to a key exchange protocol.

By negotiation of a SA between two ports, SAKs exchanged between the two ports secure outbound traffic over transmitting SCs from either port to the other and inbound traffic over receiving SCs from either port to the other, allowing either port (in the event that both ports are encryption-capable ports) to encrypt packets which the other port may decrypt, and to decrypt data packets encrypted by the other port.

In a step 308 of the secure network link establishing method 300, a processing unit configures the encryption-incapable port to operate in an encrypted packet forwarding mode.

According to example embodiments of the present disclosure, a switch control plane may include computer-executable instructions executable by processing units to configure an encryption-incapable port of the network device to operate in one of two modes. For brevity, a first mode is henceforth referenced as an encrypted packet non-forwarding mode, and a second mode is henceforth referenced as an encrypted packet forwarding mode.

An encryption-incapable port operating in an encrypted packet non-forwarding mode may receive encrypted packets, but cannot forward them, as it cannot provide a secure network link for forwarding the encrypted packet; thus, each encrypted packet received is either dropped, or flooded across all other ports of the network device.

An encryption-incapable port operating in an encrypted packet forwarding mode may receive encrypted packets and forward them over a secure network link, as shall be described with reference to the subsequent steps of the secure network link establishing method 300.

In a step 310 of the secure network link establishing method 300, a processing unit reserves an encryption-capable port of the network device to process packets in a circular forwarding mode.

According to example embodiments of the present disclosure, a switch control plane may include computer-executable instructions executable by the processing unit to configure an encryption-capable port of the network device to be reserved. A reserved encryption-capable port reserved in a “circular forwarding mode” according to example embodiments of the present disclosure does not forward packet traffic to other network devices while reserved.

Regardless of how the reserved encryption-capable port would normally forward packets, the processing unit configures the PHY of the reserved encryption-capable port to return packets to a forwarding pipeline (as shall be described subsequently) of the network device. Packet traffic which is not forwarded while the PHY is configured in circular forwarding mode may be placed in a forwarding pipeline to be forwarded again by a processing unit according to a forwarding action defined in a lookup table, as shall be described subsequently.

It should be understood that a PHY processing packets in a circular forwarding mode may further enable the access-controlled network domain to include a virtual private network (“VPN”) between two networks, implemented by an IP tunnel between the two networks. As known to persons skilled in the art, an IP tunnel between two networks may be implemented between physical interfaces of a network device of each network, or between virtual interfaces (such as loopback interfaces) of a network device of each network. Conventionally, in order to implement an access-controlled network domain including a VPN between two networks implemented by an IP tunnel between loopback interfaces, implementation of access-controlled network domains may be limited to the Internet Protocol Security (“IPsec”) protocol. However, by the configuration of reserved encryption-capable ports to process packets in circular forwarding mode as described above, access-controlled network domains not based on IPsec, such as CISCO TRUSTSEC and other implementations based on MACsec, may implement IP tunnels using circular forwarding reserved ports as endpoints of the IP tunnel, thereby enabling broader implementation of access-controlled network domains by protocols other than IPsec.

Furthermore, after configuration of a first forwarding rule as shall be subsequently described with reference to step 314, the encryption-incapable port will forward each ingress packet and each egress packet received to the reserved encryption-capable port. Since the encryption-incapable port receives encrypted ingress packets over the secured network link, and cannot decrypt them, the encryption-incapable port forwards the encrypted packets to the reserved port for decryption. Since the encryption-incapable port should not forward non-encrypted packets over the secured network link, and it cannot encrypt them, the encryption-incapable port forwards the non-encrypted packets to the reserved port for encryption.

It should be understood that an encryption-capable port need not be reserved for only one encryption-incapable port, and a same reserved encryption-capable port may be utilized by any number of encryption-incapable ports of the same network device. According to example embodiments of the present disclosure, the secure network link establishing method 300 may be performed for any number of encryption-incapable ports (as long as a total bandwidth of the encryption-incapable ports does not exceed a bandwidth of the reserved encryption-capable port - for example, a reserved encryption-capable port having a bandwidth of 100 gigabits per second may be utilized by up to ten encryption-incapable ports of 10 gig; and as long as the PHY of the network device has free SCs configurable for the performance of step 312 (as shall be subsequently described) while only performing step 310 once for one reserved encryption-capable port.

According to example embodiments of the present disclosure, encryption-capable ports are not reserved indefinitely, and may be freed at any time. For example, as shall be subsequently described, the processing unit may configure any number of encryption-incapable ports to operate in an encrypted packet non-forwarding mode, then lift a reservation of an encryption-capable port, thus returning the encryption-capable port (as well as the encryption-incapable ports) to normal operation.

In a step 312 of the secure network link establishing method 300, a processing unit configures a PHY of the network device to perform one of encryption or decryption over each of a first secure channel (“SC”) and a second SC using SAKs.

As described above, according to example embodiments of the present disclosure, encryption-capable ports should be capable of transmitting and receiving encrypted data packets as electrical signals on the underlying PHY over at least two SCs, a first secure channel transmitting encrypted packets (after encrypting the packets) and a second secure channel receiving encrypted packets (and then decrypting the packets). Thus, a PHY may be configured to encrypt over a first SC using the SAKs, and the PHY may be configured to decrypt over a second SC using the SAKs.

It should be understood that reserving one encryption-capable port according to step 310 and configuring a PHY according to step 312 need not be performed one-to-one. The processing unit may perform step 312 any number of times for a single performance of step 310, as long as the PHY of the network device is configured to perform encryption and decryption over two SCs, respectively. For example, commonly, PHYs of network devices may have 16 SCs or 32 SCs; thus, the processing unit may perform step 312 up to 8 times or up to 16 times, respectively, for up to 8 or up to 16 different encryption-incapable ports of a network device.

Moreover, it should be understood that, according to example embodiments of the present disclosure, a PHY configured in this manner may be further configured to tag each encrypted packet with an incrementing packet number, for the purpose of implementing replay attack protection. For example, the MACsec and MKA protocols each configure a processing unit to perform replay attack protection by configuring a replay window, containing a range having a lower bound and an upper bound. As known to persons skilled in the art, the processing unit may be configured to perform replay protection by dropping received packets which are tagged with packet numbers outside the replay window.

In a step 314 of the secure network link establishing method 300, a processing unit configures redirection of packets received over the SA to the reserved encryption-capable port.

The processing unit may configure redirection of packets in a lookup table of a forwarding pipeline of the network device. A forwarding pipeline, as known to persons skilled in the art, may be a structure in memory of a switch control plane, configured to hold a collection of packets to be forwarded, and configuring the processing unit to parse headers of each packet, and determine a forwarding action for each packet. For example, the processing unit may be implemented by an ASIC, and the memory may be implemented by TCAM configured for the ASIC to write data to and read data from. The lookup table may configure the processing unit to parse an EtherType field of each packet header, and look up the parsed EtherType in the lookup table to determine a forwarding action for packets of that EtherType.

According to example embodiments of the present disclosure, the lookup table may be configured to include a rule having a lookup key of the hexadecimal EtherType value “88e5,” which identifies headers of packets encrypted according to MACsec. This reflects the expectation that all packets forwarded over the SA would be encrypted according to an encryption standard enforced by a network security protocol used to implement the access-controlled network domain. Such redirection would not apply to any unencrypted packets, and would not apply to any packets encrypted according to encryption standards other than the encryption standard enforced by the network security protocol used to implement the access-controlled network domain.

According to example embodiments of the present disclosure, the processing unit may perform step 312 and step 314 concurrently, at least in part.

According to example embodiments of the present disclosure, by operation of the above steps of the secure network link establishing method 300, a secure network link is established between the encryption-incapable port and the peer port. The secure network link may behave, from the perspective of the peer port, substantially like a secure network link established between the peer port and an encryption-capable port of the network device. Furthermore, in the event that the peer port is also an encryption-incapable port, the same steps of the secure network link establishing method 300 may have been performed in a similar fashion from the perspective of the peer port.

Subsequently, by operation of the below-described steps of a surrogate decryption method 400 and surrogate encryption method 500, the reserved encryption-capable port may decrypt ingress packets received at the encryption-incapable port, and encrypt egress packets to be forwarded by the encryption-incapable port.

Moreover, at any time, the processing unit may configure the encryption-incapable port to operate in an encrypted packet non-forwarding mode, and/or lift the reservation of the encryption-capable port, thus returning either or both ports to normal operation.

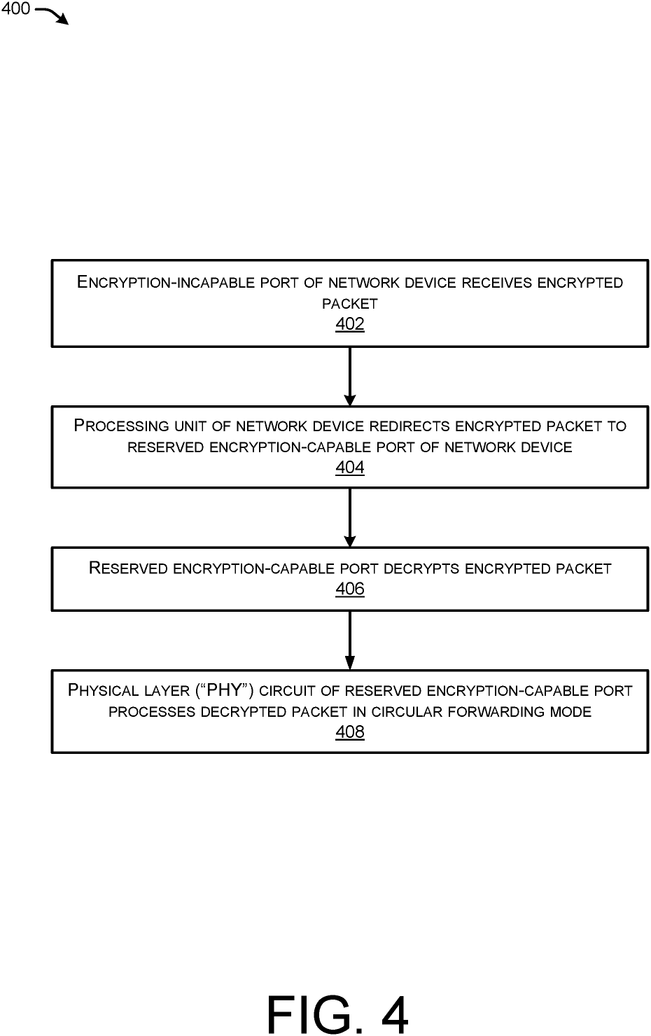

FIG. 4 illustrates a flowchart of a surrogate decryption method 400. As described above, each of the steps of the surrogate decryption method 400 may be performed by processing units of a network device, configured by one or more non-transitory computer-readable media storing computer-executable instructions. For example, the computer-executable instructions may be stored on memory of one or more ASICs.

At a step 402, an encryption-incapable port of a network device receives an encrypted packet.

It should be understood that unless the encryption-incapable port has established a secure network link as described above with reference to FIG. 3, and thereby formed an SA with a peer port, the encryption-incapable port receiving an encrypted packet would result in either dropping the packet or flooding the packet across all other ports of the network device, and thus the subsequent steps cannot be performed.

At a step 404, a processing unit of the network device redirects the encrypted packet to a reserved encryption-capable port of the network device.

It should be understood that the processing unit is configured to redirect the encrypted packet to the reserved encryption-capable port as configured above with reference to step 310 of FIG. 3.

At a step 406, the reserved encryption-capable port decrypts the encrypted packet.

At a step 408, a physical layer (“PHY”) circuit of the reserved encryption-capable port processes the decrypted packet in a circular forwarding mode.

It should be understood that the reserved encryption-capable port is configured to process the decrypted packet in circular forwarding mode as configured above with reference to step 306.

Furthermore, it should be understood that the PHY circuit of the reserved encryption-capable port may push the decrypted packet to a forwarding pipeline. The processing unit may then process the decrypted packet by configuring redirection of packets in a lookup table of a forwarding pipeline of the processing unit. For example, the lookup table may configure the processing unit to parse an EtherType field of each packet header, and look up the parsed EtherType in the lookup table to determine a forwarding action for packets of that EtherType.

Since the packet is decrypted, the EtherType of the packet will not identify an encrypted packet, and may identify, for example, a networking protocol which identifies a destination address of the packet, a next hop of the packet, a routing path of the packet, or any other information which enables the processing unit to forward the packet.

It should be understood that the processing unit may determine that the packet should egress from the network device over a particular port of the network device, without limitation as to which port, except as follows. The packet may egress over a non-secure network link, in which case it does not need to be encrypted before forwarding. Alternatively, the packet may egress over a secure network link, in which case it must be encrypted before forwarding.

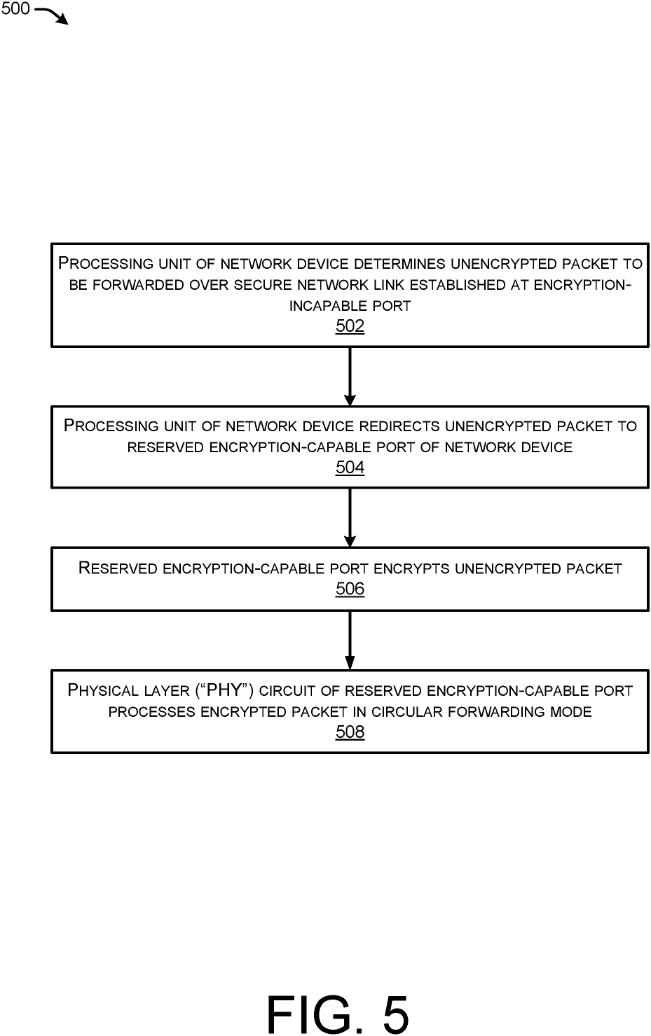

In the event that the packet egresses over a secure network link established by an encryption-capable port, a PHY circuit of the encryption-capable port may encrypt the packet in a conventional fashion without performing the surrogate encryption method as described below. However, in the event that the packet egresses over a secure network link established by an encryption-incapable port according to example embodiments of the present disclosure, a PHY circuit of the reserved encryption-capable port may encrypt the packet, as shall be described subsequently with reference to FIG. 5.

FIG. 5 illustrates a flowchart of a surrogate encryption method 500. As described above, each of the steps of the surrogate encryption method 500 may be performed by processing units of a network device, configured by one or more non-transitory computer-readable media storing computer-executable instructions. For example, the computer-executable instructions may be stored on memory of one or more ASICs.

At a step 502, a processing unit of a network device determines an unencrypted packet to be forwarded over a secure network link established at an encryption-incapable port.

It should be understood that the performance of this step will not follow the performance of the surrogate decryption method 400 described above with reference to FIG. 4. The unencrypted packet may have been previously received over any other secure or unsecure port of the network device, without limitation.

Moreover, it should be understood that, according to techniques as known to persons skilled in the art, the processing unit is configured to prepend an internal header to the unencrypted packet. The internal header may be prepended to the packet only for the duration prior to its egress from the network device, and so the internal header may be implemented according to any arbitrary format defined by a network device vendor. For example, according to network devices supplied by CISCO SYSTEMS, INC. of San Jose, California, an internal header may include 64 bytes of data, storing metadata parsed by the processing unit while the packet is in a forwarding pipeline after ingress, the metadata to be read and then discarded by the processing unit while the packet is in a forwarding pipeline prior to egress.

The internal header may store any information related to the packet which may be determined while the packet is in a forwarding pipeline after ingress, for the reference of the processing unit later handling the packet while it is in a forwarding pipeline prior to egress. For example, according to network devices supplied by CISCO SYSTEMS, INC. of San Jose, California, the internal header may be referred to as the “iETH header” (the term “iETH” having no special significance outside of internal communications within such network devices), and may indicate an egress port to which the packet should be forwarded.

The timing of prepending the internal header may vary according to various techniques as known to persons skilled in the art, and example embodiments of the present disclosure do not limit the timing of the prepending relative to the steps of the surrogate encryption method 500.

At a step 504, a processing unit of the network device redirects the unencrypted packet to a reserved encryption-capable port of the network device.

It should be understood that the processing unit is configured to redirect the unencrypted packet to the reserved encryption-capable port as configured above with reference to step 314 of FIG. 3.

At a step 506, the reserved encryption-capable port encrypts the unencrypted packet.

At a step 508, a physical layer (“PHY”) circuit of the reserved encryption-capable port processes the encrypted packet in a circular forwarding mode.

It should be understood that the reserved encryption-capable port is configured to process the encrypted packet in circular forwarding mode as configured above with reference to step 310.

Following step 508, it should be understood that the packets forwarded to processing unit of the network device may be placed in a forwarding pipeline. The processing unit may then configure redirection of packets in a lookup table of a forwarding pipeline of the processing unit. For example, the lookup table may configure the processing unit to parse an EtherType field of each packet header, and look up the parsed EtherType in the lookup table to determine a forwarding action for packets of that EtherType.

Since the packet is encrypted, the EtherType of the packet will identify an encrypted packet. However, in accordance with principles of network security, a header of an encrypted packet will not identify a destination address of the packet, a next hop of the packet, a routing path of the packet, or any other information which enables the processing unit to forward the packet.

However, according to techniques as known to persons skilled in the art as described above, the egress port of the packet is still recorded in the internal header prepended to the packet. Thus, based on the internal header, the processing unit may once again determine, from the internal header, that the packet should egress from the network device over the encryption-incapable port as described above with reference to step 502.

By the operation of the surrogate decryption method 400 and the surrogate encryption method 500 as described above, the reserved encryption-capable port may decrypt ingress packets received at the encryption-incapable port, and encrypt egress packets to be forwarded by the encryption-incapable port, supporting the secure network link established by the encryption-incapable port.

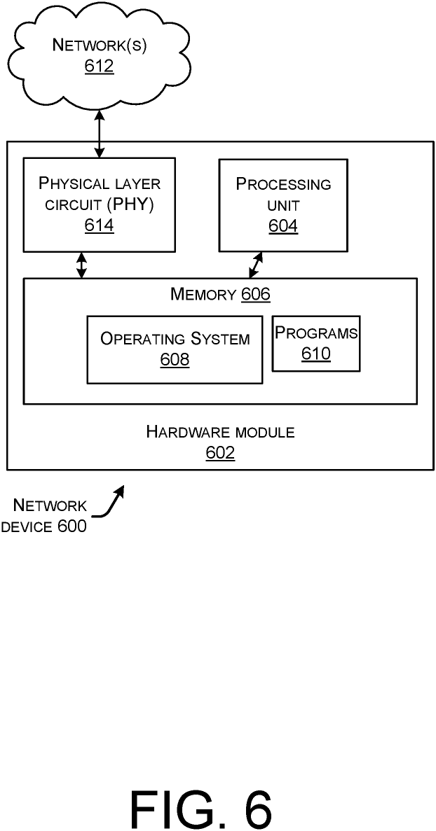

FIG. 6 shows an example architecture for a network device 600 capable of being configured to implement the functionality described above. The architecture shown in FIG. 6 illustrates a computing device assembled from modular components, and can be utilized to execute any of the software components presented herein.

The network device 600 may include one or more hardware modules 602, which may be a physical card or module to which a multitude of components or devices can be connected by way of a system bus or other electrical communication paths. Such a physical card or module may be housed in a standalone network device chassis, or may be installed in a rack-style chassis alongside any number of other physical cards or modules. In one illustrative configuration, one or more processing units 604 may be standard programmable processors or programmable ASICs that perform arithmetic and logical operations necessary for the operation of the hardware module 602.

The processing units 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

Integrated circuits may provide interfaces between the processing units 604 and the remainder of the components and devices on the hardware module 602. The integrated circuits may provide an interface to memory 606 of the hardware module 602, which may be implemented as on-chip memory such as TCAM, for storing basic routines configuring startup of the hardware module 602 as well as storing other software components necessary for the operation of the hardware module 602 in accordance with the configurations described herein. The software components may include an operating system 608, programs 610, and data, which have been described in greater detail herein.

The hardware module 602 may establish network connectivity in a network 612 by forwarding packets over logical connections between remote computing devices and computer systems. The integrated circuits may provide an interface to a physical layer circuit (PHY) 614 of the hardware module 602, which may provide Ethernet ports which enable the hardware module 602 to function as an Ethernet network adapter.

The hardware module 602 can store data on the memory 606 by transforming the physical state of the physical memory to reflect the information being stored. The specific transformation of physical state can depend on various factors, in different embodiments of this description. Examples of such factors can include, but are not limited to, the technology used to implement the memory 606, whether the memory 606 is characterized as primary or secondary storage, and the like.

For example, the hardware module 602 can store information to the memory 606 by issuing instructions through integrated circuits to alter the electrical characteristics of a particular capacitor, transistor, or other discrete component in a solid-state storage unit. Other transformations of physical media are possible without departing from the scope and spirit of the present description, with the foregoing examples provided only to facilitate this description. The hardware module 602 can further read information from the memory 606 by detecting the physical states or characteristics of one or more particular locations within the memory 606.

The memory 606 described above may constitute computer-readable storage media, which may be any available media that provides for the non-transitory storage of data and that can be accessed by the hardware module 602. In some examples, the operations performed by the network device 600, and/or any components included therein, may be supported by one or more devices similar to the hardware module 602. Stated otherwise, some or all of the operations performed by the network device 600, and/or any components included therein, may be performed by one or more hardware modules 602 operating in a networked, distributed or aggregated arrangement over one or more logical fabric planes over one or more networks.

By way of example, and not limitation, computer-readable storage media can include volatile and non-volatile, removable and non-removable media implemented in any method or technology. Computer-readable storage media includes, but is not limited to, TCAM, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the memory 606 can store an operating system 608 utilized to control the operation of the hardware module 602. According to one embodiment, the operating system comprises the CISCO NX-OS operating system from CISCO SYSTEMS INC. of San Jose, California. It should be appreciated that other operating systems can also be utilized. The memory 606 can store other system or application programs and data utilized by the hardware module 602.

In one embodiment, the memory 606 or other computer-readable storage media is encoded with computer-executable instructions which transform any processing units 604 from a general-purpose computing system into a special-purpose computer capable of implementing the embodiments described herein. These computer-executable instructions specify how the processing units 604 transition between states, as described above. According to one embodiment, the hardware module 602 has access to computer-readable storage media storing computer-executable instructions which, when executed by the hardware module 602, perform the various processes described above with regard to FIGS. 1-5. The hardware module 602 can also include computer-readable storage media having instructions stored thereupon for performing any of the other computer-implemented operations described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A network device comprising:
one or more processing units; and
one or more non-transitory computer-readable media storing computer-executable instructions that, when executed by the one or more processing units, cause the one or more processing units to:
secure a network link between an encryption-incapable port of the network device and a port of a peer network device using security association keys (SAKs) of a security association (SA) exchanged between the network device and the peer network device according to a key exchange protocol; and
configure redirection of packets received over the SA to a reserved encryption-capable port of the network device.

2. The network device of claim 1, wherein redirection of packets to a reserved encryption-capable port is configured in a lookup table of a forwarding pipeline of the network device.

3. The network device of claim 1, wherein the network device and the peer network device are members of a connectivity association (CA); and
wherein the SAKs are derived from connectivity association key (CAKs) of the network device and the peer network device.

4. The network device of claim 3, wherein the instructions further cause the one or more processing units to configure a PHY of the network device to perform one of encryption or decryption over each of a first secure channel (SC) and a second SC using the SAKs.

5. The network device of claim 4, wherein the instructions further cause the one or more processing units to configure the PHY to tag each encrypted packet sent and received over the first SC and the second SC with an incrementing packet number.

6. The network device of claim 1, wherein the instructions further cause the one or more processing units to configure processing packets from the reserved encryption-capable port in a circular forwarding mode.

7. The network device of claim 1, wherein the instructions further cause the one or more processing units to configure forwarding of encrypted packets from the reserved encryption-capable port based on an internal header of the encrypted packets.

8. A method comprising:
securing, by a network device, a network link between an encryption-incapable port of the network device and a port of a peer network device using security association keys (SAKs) of a security association (SA) exchanged between the network device and the peer network device according to a key exchange protocol; and
redirecting packets received over the SA to a reserved encryption-capable port of the network device.

9. The method of claim 8, wherein redirection of packets to a reserved encryption-capable port is configured in a lookup table of a forwarding pipeline of the network device.

10. The method of claim 8, wherein the network device and the peer network device are members of a connectivity association (CA); and
wherein the SAKs are derived from connectivity association key (CAKs) of the network device and the peer network device.

11. The method of claim 10, further comprising configuring a PHY of the network device to perform one of encryption or decryption over each of a first secure channel (SC) and a second SC using the SAKs.

12. The method of claim 11, further comprising tagging, by the PHY, each encrypted packet sent and received over the first SC and the second SC with an incrementing packet number.

13. The method of claim 8, further comprising processing, by a processing unit of the network device, packets from the reserved encryption-capable port in a circular forwarding mode.

14. The method of claim 8, further comprising forwarding, by a processing unit of the network device, encrypted packets from the reserved encryption-capable port based on an internal header of the encrypted packets.

15. A physical layer (PHY) circuit configured to:
establish a network link between an encryption-incapable port of the network device and a port of a peer network device, the network link being secured using security association keys (SAKs) of a security association (SA) exchanged between the network device and the peer network device according to a key exchange protocol; and
redirect packets received over the SA to a reserved encryption-capable port of the PHY circuit.

16. The PHY circuit of claim 15, wherein the network device and the peer network device are members of a connectivity association (CA); and
wherein the SAKs are derived from connectivity association key (CAKs) of the network device and the peer network device.

17. The PHY circuit of claim 16, wherein the PHY circuit is further configured to perform one of encryption or decryption over each of a first secure channel (SC) and a second SC using the SAKs.

18. The PHY circuit of claim 17, wherein the PHY circuit is further configured to tag each encrypted packet sent and received over the first SC and the second SC with an incrementing packet number.

19. The PHY circuit of claim 15, wherein the PHY circuit is further configured to decrypt, by the reserved encryption-capable port, an encrypted packet and process the decrypted packet in a circular forwarding mode.

20. The PHY circuit of claim 15, wherein the PHY circuit is further configured to encrypt, by the reserved encryption-capable port, an unencrypted packet to generate an encrypted packet and process the encrypted packet in a circular forwarding mode.
